(19) United States
(12) Patent Application Publication
(10) Pub. No.: US 2001/0048987 A1
(43) Pub. Date: Dec. 6, 2001

(54) Packaging materials for transdermal drug delivery systems

(76) Inventor: David Kanios, Miami, FL (US)

Correspondence Address: Noven Pharmaceuticals, Inc., 11960 S.W. 144th Street, Miami, FL, 33186, US

(21) Appl. No.: 09/804,926

(22) Filed: Mar. 13, 2001

Related U.S. Application Data
(60) Provisional application No. 60/189,333, filed on Mar. 14, 2000.

(51) Int. Cl. B32B 1/02

(52) U.S. Cl. 428/35.2

(57) ABSTRACT

Compositions and methods for producing laminate materials in packaging a transdermal drug delivery system comprising a rubber modified acrylonitrile methyl acrylate copolymer film, alone or in combination with a polyester film, wherein the active drug incorporated in the transdermal system remains substantially solubilized and stable in the system during storage prior to use. The packaging laminate is preferably translucent to allow visual inspection of its contents, and has sufficient tear resistance to substantially provide child resistant and/or proof properties.

### BACKGROUND OF THE INVENTION

This invention relates generally to packaging materials for transdermal drug delivery systems and, more particularly, to materials and methods of providing transdermal system packaging that improves stability and shelf-life of the drug during storage.

The use of transdermal drug delivery systems or “patches” as a means to topically administer a drug is well known. Such systems incorporate the drug into a carrier composition, such as a polymeric and/or pressure-sensitive adhesive composition, from which the drug is delivered at therapeutically effective amounts by absorption through skin or mucosa of the user.

Such transdermal systems are commercially available for drugs such as nitroglycerin, nicotine, estradiol, lidocaine and other pharmaceuticals. These transdermal drug delivery devices typically are affixed adhesively to the skin or mucosa of a user, and the drug diffuses at a controlled rate from a polymer reservoir or layer into the skin or mucosa and absorbed into the blood.

Conventional transdermal systems rely upon administration of solubilized drug. The ability of a transdermal system to deliver a therapeutically effective amount of a drug for the intended duration of use generally requires that the drug remain solubilized and stable in the carrier composition while in storage prior to use.

It is known that certain formulational factors can affect the stability of a drug in a transdermal system. Such formulational factors generally relate to the chemical reactivity between the various components making up the drug carrier composition, such as adhesives, solvents and enhancers. For example, many transdermal systems use a pharmaceutically acceptable pressure-sensitive adhesive as the means to contain the drug and/or attach the system to a user. However, it has been found that the functionality of these adhesives can significantly affect the drug's solubility in the carrier compositions, thereby altering drug flux upon application to the user. See, for example, U.S. patent Ser. Nos. 09/163,351 and 09/479,966.

Many transdermal systems rely upon enhancers to improve or increase penetration of the drug at the site of application of the system. However, certain enhancers may react with drugs to cause their degradation into by-products that can interfere with drug penetration and delivery. See, for example, U.S. Pat. No. 6,024,974.

It is also well known that common environmental factors such as the presence of water (in liquid or vapor form), air and/or light can also adversely affect the stability of some drugs. See, for example, U.S. Pat. No. 5,077,104. Such environmental factors can also affect the solubility of the drug in the carrier composition which in turn can also significantly impact the storage stability or shelf-life of the transdermal system. For example, moisture tends to promote crystal growth or formation for many drugs during storage of a transdermal system. Since only solubilized drug is available for delivery out of a transdermal system, the package or container for the transdermal system must provide a barrier to such environmental factors.

Product packaging is usually configured in a manner that defines a space to surround the transdermal system, such as a pouch, in order to provide protection from the environment. The product packaging can be flexible or rigid. Suitable materials used, whether singularly, in combination, as laminates (cold sealed, heat sealed or flood or pattern coated with natural or synthetic adhesives) or as coextrusions, to form the packaging are well known in the art and include films or sheets of polyethylene, polyester, polypropylene, polyurethane, polyolefin, polyvinyl alcohol, polyvinyl chloride, polyvinylidene, polyamide, vinyl acetate resins, BAREX®, ethylene/vinyl acetate copolymers, ethylene/ethylacrylate copolymers, metal-vapor deposited films or sheets thereof, rubber sheets or films, expanded synthetic resin sheets or films, non-woven fabrics, fabrics, knitted fabrics, clothes, foils and papers.

U.S. Pat. No. 5,008,110 discloses that certain polyolefin materials used for transdermal devices tend to absorb lipophilic solvents and/or enhancers, which can significantly decrease the drug's solubility in the carrier composition, as well as cause physical failure of the packaging material.

U.S. Pat. No. 4,943,435 discloses that nicotine will adversely affect many common transdermal system component materials such as adhesives, membranes, backings and release liners.

It has been unexpectedly discovered that methylphenidate can be unstable and lost by absorption in the presence of certain types of packaging materials used for transdermal systems. Methylphenidate has the following general formula:

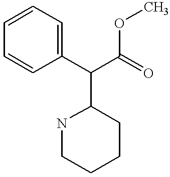

The biological activity of methylphenidate, like many pharmaceuticals, fragrances, food additives and agrochemicals, is associated with its absolute molecular configuration. It is a “chiral compound,” i.e., exists as different structural forms that have the ability to rotate the plane of plane-polarized light.

In describing such an optically active compound, the prefixes D and L or R and S are used to denote the absolute configuration of the molecule about its chiral center(s). The prefixes d and l or (+) and (−) are employed to designate the sign of rotation of plane-polarized light by the compound, with (−) or l meaning that the compound is levorotatory. A compound prefixed with (+) or d is dextrorotatory. There is no correlation between nomenclature for the absolute stereochemistry and for the rotation of an enantiomer. Thus, D-lactic acid is the same as (−) lactic acid, and L-lactic acid is (+). For a given chemical structure, these chiral compounds exist as a pair of enantiomers (called stereoisomers) which are identical except that they are non-superimposable mirror images of one another. A specific stereoisomer may also be referred to as an enantiomer, and a mixture of such isomers is often called an enantiomeric or racemic mixture.

Stereochemical purity can be of importance in the field of pharmaceuticals, where 50 of the top 100 drugs worldwide exhibit chirality. See, for example, S.C. Stinson, Chemical & Engineering News, American Chemical Society, Washington, D.C., Vol. 76 (Sep. 21, 1998) pg. 83; and “Chiral Drugs,” S.C. Stinson, Chemical & Engineering News, American Chemical Society, Washington, D.C., (Oct. 9, 1995). A case in point is provided by the L-form of the beta-adrenergic blocking agent, propranolol, which is known to be 100 times more potent than the D-enantiomer.

Furthermore, optical purity is important since certain isomers may actually be deleterious rather than simply inert. For example, it is suggested that the D-enantiomer of thalidomide is a safe and effective sedative when prescribed for the control of morning sickness during pregnancy, while the corresponding L-enantiomer is believed to be a potent teratogen. There is a growing demand to market a chiral drug in enantiomerically pure form or substantially reduce the amount of inactive enantiomers.

Methylphenidate exists as four enantiomers which are the (2R:2′R)-(+)-threo-enantiomer, the (2S:2′S)-(−)-threo-enantiomer, the (2R:2′S)-(+)-erythro-enantiomer, and the (2S:2′R)-(−)-erythro-enantiomer, but only the d-threo-methylphenidate is significantly pharmacodynamically active. The degradants of methylphenidate are also essentially inactive.

The present invention is therefore directed to providing packaging materials for stabilizing a transdermal system during storage that contains a drug, particularly a chiral drug or active enantiomer(s) thereof, comprising a rubber modified acrylonitrile methyl acrylate copolymer alone or in combination with a polyester.

### SUMMARY OF THE INVENTION

It is therefore an object of this invention to provide a packaging material for a transdermal drug delivery system that improves stability and shelf-life.

It is therefore another object of this invention to provide a packaging material for a transdermal system that will not significantly react with or degrade the drug or other components of the system, and further protect the system from degradation by environmental factors such as water, air and/or light, during storage of the system prior to use.

It is also an object of this invention to provide a packaging material for a transdermal system that improves the stability of chiral drugs and active enantiomers thereof contained in a transdermal system during its storage prior to use.

It is a further object of this invention to provide a packaging material in the form of a laminate that increases the stability and shelf-life of a transdermal system, and has increased tear resistance such that it can be constructed into a substantially child resistant and/or proof pouch.

It is still another object of this invention to provide a packaging material for a transdermal system in the form of a pouch comprising barrier materials to protect the system from degradation and loss by internal and external factors, yet be sufficiently translucent so as to permit visual inspection and examination of the pouch contents.

It is additionally an object of this invention to provide a method for making a pouch from laminate materials that provide improved stability and tear resistant properties, and permit visual inspection of the pouch contents.

### BRIEF DESCRIPTION OF DRAWINGS

FIG. 1 is a cross-sectional illustration of the packaging material in the embodiment of a laminate used to form a pouch.

### DETAILED DESCRIPTION OF THE INVENTION

The foregoing and other objects are achieved by this invention which provides methods and materials for producing transdermal drug delivery system packaging wherein the drug incorporated in the transdermal system remains substantially solubilized and stable in the carrier composition of the transdermal system while the system is in storage prior to use.

The term “topical” or “topically” is used herein in its conventional meaning as referring to direct contact with an anatomical site or surface area on a mammal including skin, teeth, nails and mucosa.

The term “mucosa” as used herein means any moist anatomical membrane or surface on a mammal such as oral, buccal, vaginal, rectal, nasal or ophthalmic surfaces.

The term “transdermal” as used herein means passage into and/or through skin or mucosa for localized or systemic delivery of an active agent.

The term “system” as used herein is intended to broadly mean a transdermal drug delivery device topically applied to a mammal for the purposes of providing some beneficial or therapeutic effect, and includes all patch-type devices commonly referenced in the art as reservoir, matrix, adhesive matrix, in-line, membrane and multi-layer devices, iontophorectic devices, and medicated bandages and pads. Further details and examples of transdermal systems generally are described in U.S. Pat. Nos. 4,994,267, 5,006,108, 5,446,070, 5,474,787, 5,656,286, 5,719,197, and Ser. Nos. 60/115,987 and 09/163,351, all of which are assigned to Noven Pharmaceuticals, Inc. and incorporated herein by reference.

The term “carrier composition” as used herein refers to any non-aqueous material known in the art as suitable for transdermal drug delivery administration, and includes any polymeric material into which a drug may be solubilized, alone or in combination or admixture with the other additives and excipients including solvents, permeation enhancers, diluents, stabilizers, fillers, clays, buffering agents, biocides, humectants, anti-irritants, antioxidants, preservatives, plasticizing agents, cross-linking agents, flavoring agents, colorants, pigments and the like. Regardless of the type of transdermal system used to practice the invention, the carrier composition is preferably substantially free of water (i.e., the composition contains less than about 10% water by weight, preferably less than about 5% by weight, and most preferably less than about 3% water by weight based upon the total weight of the composition prior to its topical application).

The term “solubilized” is intended to mean that in the carrier composition there is an intimate dispersion or dissolution of the active agent at the crystalline, molecular or ionic level. As such, the active agent is considered herein to be in “non-crystallized” form when in the compositions of the present invention.

As used herein, the term “flux” is defined as the absorption of the drug through the skin or mucosa, and is described by Fick's first law of diffusion:

J=−D (dCm/dx),

Where J is the flux in g/cm2/sec, D is the diffusion coefficient of the drug through the skin or mucosa in cm2/sec and Dcm/dx is the concentration gradient of the drug across the skin or mucosa.

The packaging material for use as the primary (or inner) layer 11 is thermoplastic polymers with good resistance to solvents and air, and in particular, rubber modified acrylonitrile methyl acrylate copolymers. Such materials are disclosed, for example, in U.S. Pat. No. 3,426,102, and are commercially sold under the trademark Barex® by BP Chemicals, Inc., Cleveland, Ohio. Various material compositions of Barex® resins are available, for example, Barex® 210, 2218 (which has a higher rubber modified content than 210), and 214. An especially preferred material is Barex® 210.

In practice of the preferred embodiments of the invention, the thickness of primary layer 11 is from about 0.5 mil to about 2.5 mil, more preferably from about 0.75 mil to about 1.5 mil, and even more preferably from about 1.0 mil to about 1.5 mil. While thinner and thicker widths may be employed, inner layer 11 should not be so thin so as to compromise its barrier and stabilizing properties, nor too thick so as to adversely affect sealing and packaging properties, such as sealing to form a pouch.

As used herein, the term “pouch” refers to a package or other container which contains a transdermal system and is sealed on at least one side. A pouch can comprise two sheets or laminates of the packaging material of this invention that has been joined along all its edges. It may also comprise a single sheet or laminate that has been folded and sealed all along its edges, or along all non-folded edges. It may further comprise a bag or pocket that is sealed along one or more edges. Sealing can be accomplished by heat, ultrasound, laser, or adhesive and the like. The preferred packaging material is self-sealing (i.e., able to form a stable bond between two facing surfaces of the same material without the use of an adhesive).

While a pouch consisting of Barex® film alone can provide protection from degradation and/or loss of methylphenidate base during storage of such transdermal system, it is desirable to provide a secondary (or outer) layer 12 in order to augment its maintenance and stabilizing properties, to increase tear resistance such that the pouch may function as a child resistant/proof package, to provide a more cosmetically appealing covering, and/or to provide an easier printing substrate. The secondary layer 12 can be a film or laminate comprising any suitable material known in the art for packaging such as metal foils, polyethylenes, polyesters, vinyl acetate resins, ethylene/vinyl acetate copolymers, polyurethanes, polyvinyl chloride, woven and non-woven fabric, cloth and papers. In practice of the preferred embodiments of the invention, the thickness of secondary layer 12 is from about 0.2 mil to about 3.0 mil, more preferably from about 0.2 mil to about 1.5 mil, and even more preferably from about 0,5 mil to about 1.0 mil. While thinner and thicker widths may be employed, secondary layer 12 should not be so thin so as to compromise its barrier and tear resistance properties to the pouch, nor too thick so as to adversely affect sealing to primary layer 11 or packaging properties of the pouch.

Particularly preferred materials for use as the secondary layer are also translucent materials such that the ability to view and inspect the contents of the package is not lost. The preferred secondary layer material is a film of polyester. Polyester films further act to inhibit transmission of air and moisture.

Particularly preferred polyesters are those commercially sold under the trademark Mylar® and Melinex by E.I. du Pont de Nemours and Company, Wilmington, Del., and include Mylar® S, Melinex® S and Melinex® 800 polyester films.

Secondary layer 12 can be affixed to primary layer 11 by any technique known in the art. Attachment by means of heat fusion or an adhesive, particularly a pressure-sensitive adhesive, is preferred. Use of an adhesive is preferred in order to achieve greater tear resistance properties which are desirable in creating child resistant/proof packaging.

An adhesive is a pressure-sensitive adhesive within the meaning of the term as used herein if it has the properties of a pressure-sensitive adhesive per se or if it functions as a pressure-sensitive adhesive by admixture with tackifiers, plasticizers, cross-linking agents or other additives. Pressure-sensitive adhesives include all of the non-toxic natural and synthetic polymers known or suitable for use in transdermal systems including solvent-based, hot melt and grafted adhesives, and may be used alone or in combinations, mixtures or blends. Examples of suitable adhesives include polyacrylates, polysiloxanes, silicones, rubbers, gums, polyisobutylenes, polyvinylethers, polyurethanes, styrene block copolymers, styrene/butadiene polymers, polyether block amide copolymers, ethylene/vinyl acetate copolymers, and vinyl acetate based adhesives. Suitable polysiloxanes include those commercially available and sold under the trademark BIO-PSA® by Dow Corning Corporation, Midland, Mich.

The pressure-sensitive adhesives particularly useful in practicing this invention include polyacrylates of one or more monomers of acrylic acids or other copolymerizable monomers. Polyacrylate adhesives also include polymers of alkyl acrylates and/or methacrylates and/or copolymerizable secondary monomers, or monomers with functional groups. The term “polyacrylate” is intended to be used interchangeably with the terms acrylic, acrylate and polyacrylic as used herein and as known in the art. Suitable pressure-sensitive acrylic adhesives are commercially available and include those sold under the trademark DURO-TAK® by National Starch and Chemical Company, Bridgewater, N.J., and GELVA® Multipolymer Solution by Solutia, Inc., St. Louis, Mo.

In practice of the preferred embodiments of the invention, the adhesive is applied to secondary layer 12 and dried to a thickness that should preferably not exceed about 1 mil, and is preferably in a range from about 0.3 mil to about 0.75 mil, prior to pressure sealing the adhesive coated secondary layer 12 to primary layer 11.

In order to provide protection from light for drugs which may further be subject to degradation by light, it may be desirable to use a modified form of secondary layer 12 material. For example, the material may be tinted to provide a partial barrier affecting only certain wavelengths of light, or be substantially opaque as in a metalized polyester film.

In a preferred embodiment, the packaging material is a laminate comprising (a) primary layer 11 that will not significantly absorb the drug or other components of the transdermal carrier composition, or otherwise negatively affect the physical characteristics of the drug or other components of the transdermal carrier composition, and (b) secondary layer 12 that augments the maintenance and protection characteristics of the inner layer, but further imparts increased tear resistance such that the packaging material is substantially child resistant/proof. The novel laminate packaging material can be in any convenient form that permits the effective closure of a transdermal system, such as a pouch. The perimeter of the pouch can be in any design, shape or form, irregular or uniform. Uniform shapes such as squares, rectangles, circles and ovals are preferred in order to facilitate the sealing and manufacturing processes.

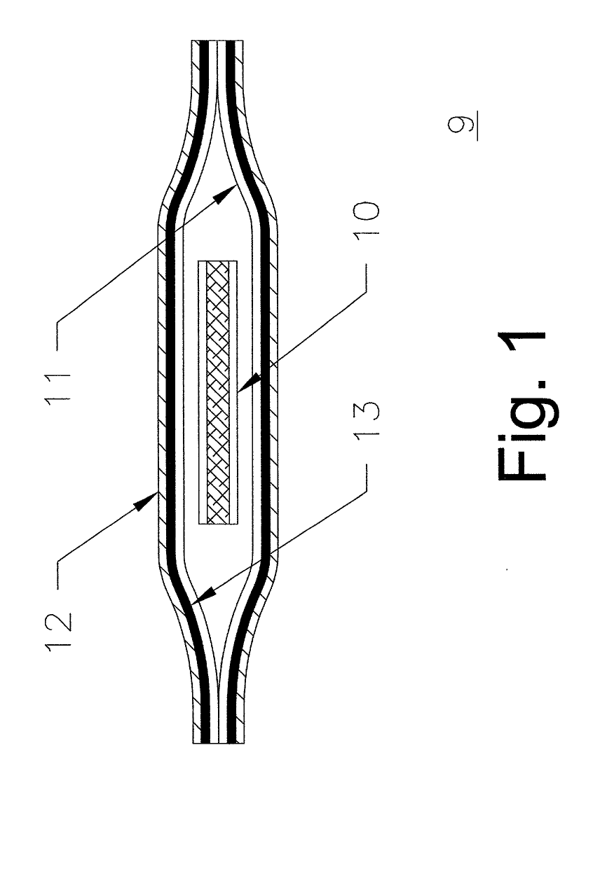

Reference to FIG. 1 shows a cross-sectional view of a preferred embodiment of the packaging laminate in the form of pouch 9 containing transdermal system 10 according to the present invention. The primary layer 11 comprising a rubber modified acrylonitrile methyl acrylate copolymer is affixed to secondary layer 12 comprising a polyester by means of adhesive 13. The laminate in the form of pouch 9 may be sealed at the edges for example by heat. The novel laminate packaging material in the form of a pouch not only provides maintenance and protection of the drug contained in the transdermal system from degradation from internal and environmental factors, but further provides tear resistance characteristics suitable to make it child resistant/proof.

The present invention is generally directed to packaging materials for stabilizing a transdermal system that contains methylphenidate as the drug. The methylphenidate used for testing in the examples was in base form and comprised a racemate of about 50% each of d-threo-methylphenidate and 1-threo-methylphenidate. The major degradants include ritalinic acid and the erythro-enantiomers (both d:l and l:d). The term “degradant” as used herein refers to any impurity, metabolite, non-metabolite, enantiomer and the like that exhibits no or significantly lower pharmacodynamic activity for a particular therapeutic purpose or deserved beneficial effect than the drug molecule or another enantiomer thereof. Correspondingly, an “active” enantiomer refers to the isomer of a chiral drug that exhibits greater pharmacodynamic activity that its counterpart enantiomers. Loss of active drug, either by absorption into the packaging materials or by degradation during storage, reduces the amount of the active enantiomer, thus reducing the amount of active drug available to deliver a therapeutically effective amount.

As used herein, “therapeutically effective” means an amount of drug that is sufficient to achieve the desired local or systemic effect or result, such as to prevent, cure, diagnose, mitigate or treat a disease or condition, when applied topically over the duration of intended use. The amounts necessary are known in the literature or may be determined by methods known in the art, but typically range from about 0.1 mg to about 20,000 mg, and preferably from about 0.1 mg to about 1,000 mg, and most preferably from about 0.1 to about 500 mg per human adult or mammal of about 75 kg body weight per 24 hours.

Although the particularly preferred embodiments of the present invention are generally directed to packaging materials useful for a transdermal system containing methylphenidate, particularly in base form, packaging materials of the present invention are useful for systems containing any drug that is incompatible (unstable) with commonly used packaging materials as those described in the examples herein (such as polyethylene or polypropylene). Such drugs include chiral drugs, for example, ceftriaxone, thalidomide, propranolol, ibuprofen, ketoprofen, naproxen, peroxetine, finasteride, sertraline, paclitaxel, terfenadine, verapamil, enalapril, lisinopril, ifosamide, methyldopa, indacrinone, bupivacaine, loxiglumide, amlodipine, pyridinium, levoslmedan, ondansetron, salmeterol, ketorolac, doxazosin, cisapride, albuterol, oxybutynin, selective serotonin reuptake inhibitors such as fluoxetine, loratadine, fexofenadine, cetirizine, formoterol, triptans such as sumatriptan, doxazosin, zolpidem, sibutramine, atorvastatin, nadolol, abacavir, citalopram, nifedipine, glitazones such as troglitazone, progliotazone, and rosiglitazone, clorazepate, lorazepam, oxazepam, temazepam, omeprazole, levofloxacin, captopril, and diltiazem.

The term “drug” as used herein is intended to have the broadest meaning possible, and be used interchangeably with active agent, pharmaceutical, medicament and any substance intended to provide a beneficial effect including a therapeutic, prophylactic, pharmacological, or physiological substance, cosmetic and personal care preparations, and mixtures thereof. More specifically, any substance that is capable of producing a pharmacological response, localized or systemic, irrespective of whether therapeutic, diagnostic, cosmetic or prophylactic in nature, is within the contemplation of the invention. It should be noted that the active agents can be used singularly or in combinations and mixtures. There is no limitation on the type of active agent that can be used in this invention. However, active agents that are solid at room temperature are preferred.

The active agents contained in the carrier composition can be in different forms depending on the solubility and release characteristics desired, for example as neutral molecules, components of molecular complexes, and pharmaceutically acceptable salts, free acids or bases, or quaternary salts of the same. Simple derivatives of the drugs such as pharmaceutically acceptable ethers, esters, amides and the like which have desirable retention and release characteristics but which are easily metabolized at body pH, and enzymes, pro-active forms, pro-drugs and the like, can also be employed.

### EXAMPLES

The following procedure is illustrative of how to generally prepare a transdermal drug delivery system, and particularly describes the transdermal system used in testing the stability of a transdermal system stored in pouches of various packaging materials described in the examples.

A transdermal system containing methylphenidate base in a pressure-sensitive adhesive carrier composition was prepared by combining 6.0 part methylphenidate base along with 4.5 parts of ethyl cellulose (Ethocel® 20, Dow Chemical Corp., Midland, Mich.) in 22.75 parts of ethyl acetate. Next, 8.6 parts of a polyacrylate adhesive (GMS 3067; Solutia Inc., St. Louis, Mo.) and 24.5 parts of a polysiloxane adhesive (BIO-PSA® 7-4302; Dow Coming Corp., Midland, Mich.) were added and thoroughly mixed. The carrier composition was then wet caste at 20 mils, with a wet gap bar, onto a fluorocarbon release liner (Scotch Pak® 1022, 3M, Minneapolis, Minn.) and ran through an oven to evaporate volatile solvents. The dry composition was laminated to a (polyester) backing film (Scotch Pak® 1012, 3M, Minneapolis, Minn.). The carrier composition had the ingredient concentrations on a dry weight basis as shown below.

| Ingredient | Dry Weight % |
|---|---|
| Polysiloxane Adhesive | 50 |
| (BIO-PSA ® 7-4302) | |
| Polyacrylate Adhesive | 15 |
| (GMS 3067) | |
| Ethyl Cellulose | 15 |
| (Ethocel ® 20) | |
| Methylphenidate Base | 20 |
| | 100 |

Transdennal system samples of 10 cm² were then die cut and placed into 2.5 in² heat-sealed pouches comprised of the various material combinations described in each of the following examples.

Example 1: A 1.25 mil film of Barex® 210 heat laminated to 0.35 mil aluminum foil. The aluminum foil was then bonded to 35# Kraft paper using an adhesive (laminate material manufactured by Richmond Technology, Redlands, Calif.).

Example 2: A 1.25 mil film of Barex® 210 laminated with a polyester film using a urethane adhesive commercially available as 94035 and sold by Lawson Mardon (Shelbyville, Ky.).

Example 3: A 1.25 mil film of Barex® 210 laminated with aluminum foil using an adhesive, which is then laminated to a polyester film using an adhesive, which is commercially available as 90580 and sold by Lawson Mardon.

Example 4: A 1.25 mil film of Barex® 210 (provided by Greenway Plastics Industries Corporation, Wayne, N.J.).

Example 5: Same as Example 1.

Example 6: A 2.0 mil film of Scotch Pak® 1012 (a polyester film laminated to a ethylene/vinyl acetate heat seal layer manufactured by 3M).

Example 7: A 2.0 mil film of Scotch Pake 1009 (a polyester film laminated with aluminum foil and ethylene/vinyl heat seal layer manufactured by 3M).

Example 8: A 3 mil film of a proprietary laminate barrier film commercially available as 5488-9913 and sold by Kappler Protective Apparel & Fabrics, Inc. (Guntersville, Ala.).

Example 9: A 1.25 mil film of Barex® 210 laminated to a 2 mil polyester film using an acrylate adhesive (Duro-Tak® 87-2296 by National Starch and Chemical Corporation, Bridgewater, N.J.).

Example 10: Same as Example 9 except a 0.92 mil polyester film was used.

Example 11: Same as Example 9 except that a 0.2 mil polyester film was used.

Example 12: A 3 mil film of a proprietary laminate barrier film commercially available as 5488-99A and sold by Kappler Protective Apparel & Fabrics, Inc.

Example 13: A 2 mil polyester film.

Example 14: A 1.25 mil film of Barex® 210 heat sealed into pouch within a heat-sealed pouch of 2 mil polyester.

Three samples of each example containing the transdermal system were then placed in an oven at 80° C. for 4 days to accelerate aging (i.e., simulate shelf-life storage of about 2 years). The transdermal systems were then removed from the pouches, and placed in an extraction solution of acidified methanol after removal of the release liner. The extraction solution containing the system was sonicated for 45 minutes at room temperature. Aliquot samples were then extracted and examined by high-pressure liquid chromatography to determine and measure the percent of degradants and active drug loss.

The same extraction procedure was employed to the pouch materials to determine and measure the amount of active drug (i.e., d-threo-methylphenidate) absorbed such materials in mg by dry weight. The results are set forth in Table I.

TABLE I

| | | | Drug Absorption |
|---|---|---|---|
| Example | Total Degradation % | Drug Loss (%) | (mg) |
| 1* | 0.1 | 0 | 0.108 |
| 2 | 9.7 | 10.1 | 0.440 |
| 3 | 25.3 | 23.7 | 0.254 |
| 4 | 8.6 | 6.2 | 0.265 |
| 5 | 15.0 | 14.1 | 0.209 |
| 6 | 8.3 | 16.9 | 2.979 |
| 7 | 8.6 | 19.2 | 3.182 |
| 8 | 8.5 | 12.1 | 1.692 |
| 9 | 8.7 | 7.9 | 0.176 |
| 10 | 8.7 | 6.6 | 0.107 |
| 11 | 8.6 | 6.9 | 0.117 |
| 12 | 8.7 | 21.4 | 2.217 |
| 13 | 8.6 | 4.8 | 0.204 |
| 14 | 8.7 | 6.2 | 0.147 |

*Example 1 was used as a control which was maintained at room temperature for 4 days.

The data shows significant degradation occurs when a metal foil is incorporated into packaging laminate without first providing a barrier, such as by use of a polyester film, between the metal foil and the drug. While examples 4 and 15 consisting of single layer films provide good stability, they are not self-sealing and are different to heat seal and obtain an effective closure. Significant drug loss is also observed in the presence of vinyl acetate. The examples using the Barex® and polyester film laminates demonstrated good stability over time.

What is claimed is:

1. A method of inhibiting the loss of the active enantiomers of a chiral drug in a carrier composition of a transdermal system, comprising the steps of:
providing a laminate package material comprising:
(i) an inner layer comprising a thermoplastic polymer film, wherein said layer is free of polyolefins, metal foil and vinyl acetate; and
(ii) an outer layer affixed to said inner layer;
providing a non-aqueous carrier composition of a transdermal system comprising a chiral drug or active enantiomers thereof that degrades or is unstable when exposed to vinyl acetate and metal foil materials;
placing said carrier composition within a pouch of the laminate packaging material; and
sealing said pouch along one or more edges of the inner layer.

2. A method according to claim 1, wherein the inner layer of the laminate packaging material is self-sealing.

3. A method according to claim 1, wherein the inner layer is a film of rubber modified acrylonitrile methyl acrylate copolymers.

4. A method according to claim 3, wherein the outer layer comprises at least one polyester film affixed to the inner layer.

5. A method according to claim 4, wherein the outer layer is affixed to the inner layer by means of an adhesive.

6. A method according to claim 1, wherein the laminate packaging material is child resistant.

7. A method according to claim 1, wherein the laminate packaging material is translucent.

8. A method according to claim 1, wherein the chiral drug is selected from the group consisting of methylphenidate, a pharmaceutically acceptable salt or base of methylphenidate, and active enantiomers thereof.

9. A laminate packaging material for inhibiting degradant formation of methylphenidate or active enantiomers thereof in a non-aqueous carrier composition of a transdermal system comprising:
an inner layer of rubber modified acrylonitrile methyl acrylate copolymers, and
an outer layer comprising at least one polyester film affixed to said inner layer;
whereby both said layers are affixed by means of an adhesive and formed into a pouch.
